(19) United States
(12) Patent Application Publication
(10) Pub. No.: US 2015/0009526 A1
(43) Pub. Date: Jan. 8, 2015

(54) IMAGE TRANSMISSION PORT UNIT, IMAGE TRANSMISSION APPARATUS, IMAGE RECEPTION PORT UNIT, IMAGE RECEPTION APPARATUS, AND IMAGE TRANSMISSION AND RECEPTION SYSTEM

(71) Applicant: FUJI XEROX CO., LTD., Tokyo (JP)

(72) Inventors: Atsushi UGAJIN, Kanagawa (JP); Tomoya ISHIZAKI, Kanagawa (JP); Atsushi KITAGAWARA, Kanagawa (JP); Tsutomu HAMADA, Kanagawa (JP); Yoshinori AWATA, Kanagawa (JP)

(73) Assignee: FUJI XEROX CO., LTD., Tokyo (JP)

(21) Appl. No.: 14/188,307

(22) Filed: Feb. 24, 2014

(30) Foreign Application Priority Data
Jul. 4, 2013 (JP) 2013-140325

(51) Int. Cl. H04N 1/00; G06F 13/40; G06F 3/12

(52) U.S. Cl. CPC H04N 1/0083; H04N 1/001; G06F 3/1279; G06F 13/4068; G06F 13/409
USPC 358/1.15

(57) ABSTRACT

An image transmission port unit includes a first arrangement surface, a second arrangement surface parallel to the first arrangement surface, ten terminals arranged in the first arrangement surface and spaced apart by a predetermined pitch, and ten terminals arranged in the second arrangement surface and spaced apart by the same pitch as that of the ten terminals in the first arrangement surface. The ten terminals in the first arrangement surface include sequentially from a first to a second end two transmission terminals, one ground terminal, two transmission terminals, one ground terminal, two terminals each to be independently used, and two transmission or transmission/reception terminals. The ten terminals in the second arrangement surface include sequentially from the first to second end one ground terminal, two transmission terminals, one ground terminal, two transmission terminals, two terminals each to be independently used, one ground terminal, and one power source terminal.

### CROSS-REFERENCE TO RELATED APPLICATIONS

This application is based on and claims priority under 35 USC 119 from Japanese Patent Application No. 2013-140325 filed Jul. 4, 2013.

### BACKGROUND

(i) Technical Field

The present invention relates to an image transmission port unit, an image transmission apparatus, an image reception port unit, an image reception apparatus, and an image transmission and reception system.

(ii) Related Art

In some cases, images are transmitted and received using a transmission and reception method compliant with the DisplayPort standard.

### SUMMARY

According to an aspect of the present invention, an image transmission port unit having a first end and a second end includes a first arrangement surface and a second arrangement surface that extends parallel to the first arrangement surface. The image transmission port unit also includes ten terminals that are arranged in a row in the first arrangement surface and spaced apart from one another by a predetermined pitch, and ten terminals that are arranged in the second arrangement surface and spaced apart from one another by the same pitch as the pitch of the ten terminals in the first arrangement surface. The phase of the ten terminals in the second arrangement surface is shifted toward the second end by 180° relative to the ten terminals in the first arrangement surface. In the image transmission port unit, the ten terminals in the first arrangement surface include sequentially from the first end to the second end two terminals for transmission of a differential signal, one ground terminal, two terminals for transmission of a differential signal, one ground terminal, two terminals each to be independently used, and two terminals for reception or for transmission and reception of a differential signal. In the image transmission port unit, the ten terminals in the second arrangement surface include sequentially from the first end to the second end one ground terminal, two terminals for transmission of a differential signal, one ground terminal, two terminals for transmission of a differential signal, two terminals each to be independently used, one ground terminal, and one power source terminal.

### BRIEF DESCRIPTION OF THE DRAWINGS

Exemplary embodiment of the present invention will be described in detail based on the following figures, wherein:

FIG. 1 is an outline of a printing system that includes an exemplary embodiment of an image transmission and reception system;

FIG. 2 is a perspective view of the appearance of a plug provided at an end portion of a cable;

FIG. 3 illustrates a connection port unit to which the plug illustrated in FIG. 2 is inserted;

FIG. 4 illustrates a pin-out of a connection port unit compliant with the DisplayPort standard on an image transmission side;

FIG. 5 illustrates a pin-out of an image transmission port unit as an exemplary embodiment of the present invention;

FIG. 6 illustrates the distances between auxiliary pins and a pair of pins for transmission of a differential signal and between auxiliary pins and a pair of pins for transmission and reception of a differential signal in the comparative example illustrated in FIG. 4 and listed in Table 1;

FIG. 7 illustrates in a manner similar to FIG. 6 the distances between pins according to the present exemplary embodiment illustrated in FIG. 5 and listed in Table 2;

FIG. 8 illustrates measurement results of power of crosstalk noise at various frequencies (in GHz) of differential signals, the crosstalk noise being introduced into the auxiliary pins separated by the distances A, C, and D from the pairs of pins through which the differential signals are transmitted or received; and

FIG. 9 is a pin-out of an image reception port unit equipped in a printer illustrated in FIG. 1.

### DETAILED DESCRIPTION

An exemplary embodiment of the present invention is described below.

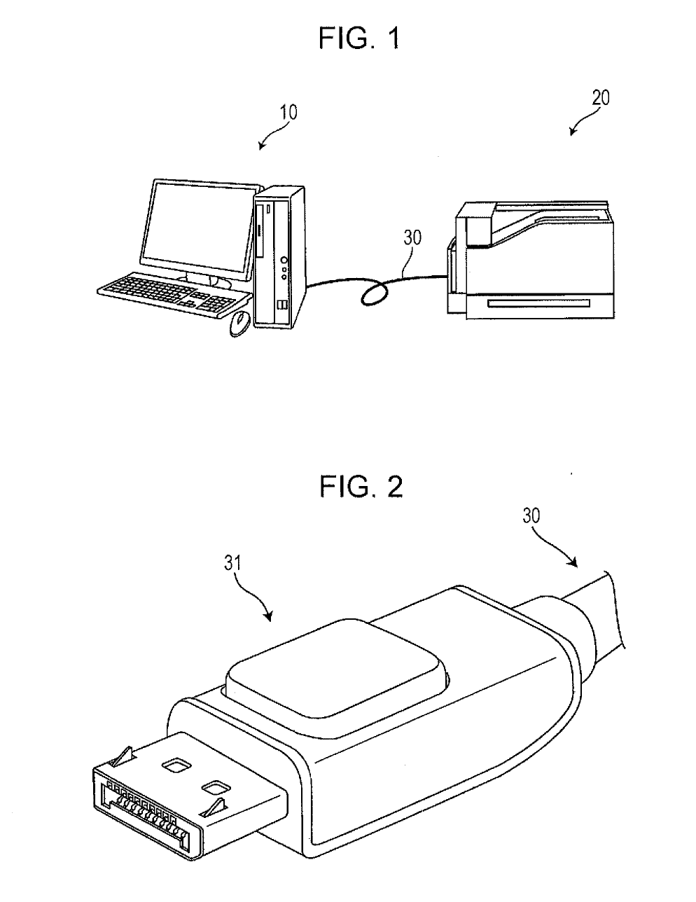

FIG. 1 is an outline of a printing system that includes an exemplary embodiment of an image transmission and reception system according to the present invention.

In FIG. 1, a computer 10, a printer 20, and a cable 30 are illustrated. The computer 10 generates an image. The printer 20 prints out the image. The cable 30 connects the computer 10 and the printer 20 to each other.

An image is structured as data in the computer 10, and the structured image data is transmitted to the printer 20 through the cable 30. The printer 20 receives the transmitted image data and prints out the image in accordance with the image data.

FIG. 2 is a perspective view of the appearance of a plug provided on an end portion of the cable.

A plug 31 having the shape illustrated in FIG. 2 is provided at the one and another end portions of the cable 30 illustrated in FIG. 1. The mechanical shape and dimensions of the plug 31 is compliant with the DisplayPort standard. The DisplayPort is an interface standard for transmission and reception of images established for digital display devices such as liquid crystal displays.

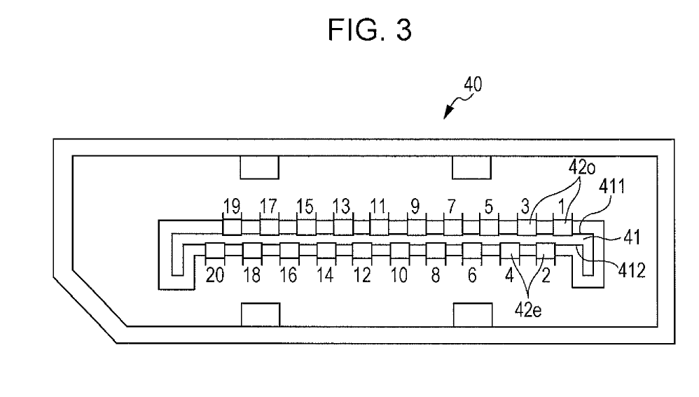

FIG. 3 illustrates a connection port unit to which the plug illustrated in FIG. 2 is inserted.

In FIG. 3, the numbers 1 to 20 indicate pin (terminal) numbers.

Here, a connection port unit 40 includes a board 41. The board 41 has a first arrangement surface 411 serving as a front surface thereof, in which odd-numbered pins 42o are arranged in a single row from a first end (end on the right side in FIG. 3) toward a second end (end on the left side in FIG. 3). The odd-numbered pins 42o are spaced apart from one another by a predetermined pitch. Also, the board 41 has a second arrangement surface 412 serving as a rear surface thereof, which extends parallel to the first arrangement surface 411. The second arrangement surface 412 is separated from the first arrangement surface 411 by a distance equal to the thickness of the board 41. Even-numbered pins 42e are arranged in the second arrangement surface 412 from the first end toward the second end similarly to the odd-numbered pins 42o. The even-numbered pins 42e are spaced apart from one another by the same pitch as that of the odd-numbered pins 42o. The phase of the even-numbered pins 42e is shifted toward the second end by 180° relative to the odd-numbered pins 42o.

The computer 10 and the printer 20 illustrated in FIG. 1 each include the connection port unit 40 illustrated in FIG. 3. The shapes of the connection port unit 40 of the computer 10 and that of the printer 20 are the same. However, the connection port unit of the computer 10 is used to transmit images. Thus, the connection port unit on the computer 10 side is referred to as an image transmission port unit here.

In contrast, the connection port unit of the printer 20 is used to receive images. Thus, the connection port unit on the printer 20 side is referred to as an image reception port unit here.

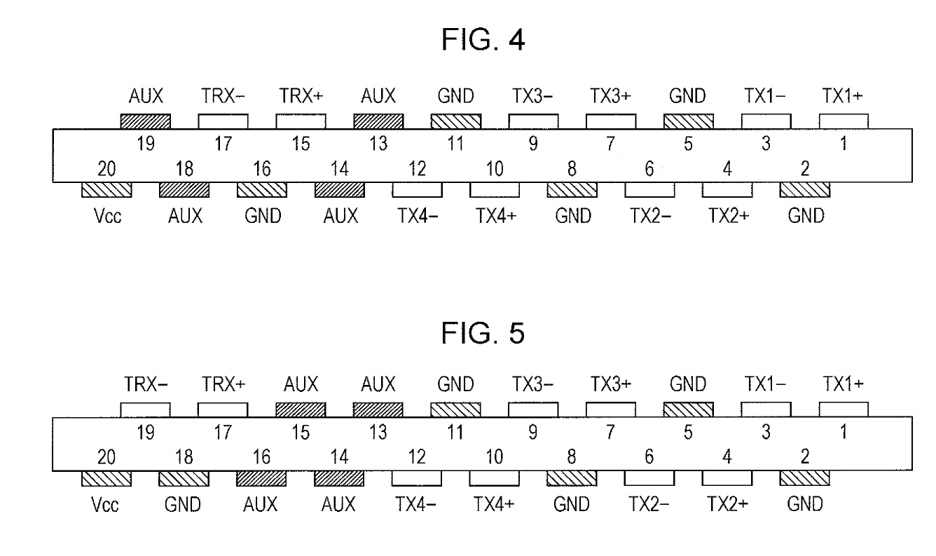

FIG. 4 illustrates a pin-out of a connection port unit compliant with the DisplayPort standard on an image transmission side. The pin-out illustrated in FIG. 4 corresponds to that of a comparative example of the present invention.

Table 1 below lists the pin-out illustrated in FIG. 4.

TABLE 1

| Pin No. | Function | Pin No. | Function |
|---|---|---|---|
| 1 | TX1+ | 2 | GND |
| 3 | TX1− | 4 | TX2+ |
| 5 | GND | 6 | TX2− |
| 7 | TX3+ | 8 | GND |
| 9 | TX3− | 10 | TX4+ |
| 11 | GND | 12 | TX4− |
| 13 | AUX | 14 | AUX |
| 15 | TRX+ | 16 | GND |
| 17 | TRX− | 18 | AUX |
| 19 | AUX | 20 | Vcc |

Here, pairs of transmission (TX) 1+ and TX1−, TX2+ and TX2−, TX3+ and TX3−, and TX4+ and TX4− pins are pairs of pins used to transmit differential signals from the computer 10 to the printer 20. Ground (GND) pins are for grounding. Transmission and reception (TRX+ and TRX−) pins are paired and usually used to receive a differential signal transmitted from the printer 20 to the computer 10. Alternatively, the TRX+ and TRX− pins may be used to transmit a differential signal from the computer 10 to the printer 20. A collector voltage (Vcc) pin is a power source pin. Pins indicated as auxiliary (AUX) in the function column are independently used to respective functions such as transmission or reception of a low-speed signal, a voltage, and a level unlike the pins for transmission or reception of differential signals.

According to the DisplayPort standard, differential signals may be transmitted at a maximum of 2.76 Gbps (1.38 GHz) through the TXn+ and TXn− pins (n=1 to 4). Also according to this standard, a signal is transmitted and received through the TRX+ and TRX− pins at a maximum of 1 Mbps (0.5 GHz), which is slower than speed at which signals are transmitted through the TXn+ and TXn− pins.

Nowadays, a further increase in image resolution is desired, and accordingly, high-speed transmission of images is desired. In this case, the amount of information to be transmitted from the printer 20 to the computer 10 is also increased. Here, the above-described trend is considered, and differential signals, the speed of which is, for example, a maximum of 4.25 Gbps (2.125 GHz) for both transmission and reception, are supported. When the signaling speed is increased to such a speed, radiation noise is increased. Although the radiation noise may be suppressed in a differential mode, there is a problem of crosstalk in the case of single-ended signals. That is, although the effects of radiation noise may be canceled out each other and suppressed in the differential mode (differential signal), in the case of the auxiliary pins (single-ended signals), unlike the case of a differential signal, the effects of radiation noise are not canceled out and the radiation noise directly affects the signals. This problem is particularly apparent when the signal strength is increased in accordance with the above-described increase in the signal speed and an increase in the length of the cable.

In view of the above-described problem related to the pin-out, a pin-out as an exemplary embodiment of the present invention is described next.

FIG. 5 illustrates a pin-out of the image transmission port unit as an exemplary embodiment of the present invention.

Table 2 below lists the pin-out illustrated in FIG. 5.

TABLE 2

| Pin No. | Function | Pin No. | Function |
|---|---|---|---|
| 1 | TX1+ | 2 | GND |
| 3 | TX1− | 4 | TX2+ |
| 5 | GND | 6 | TX2− |
| 7 | TX3+ | 8 | GND |
| 9 | TX3− | 10 | TX4+ |
| 11 | GND | 12 | TX4− |
| 13 | AUX | 14 | AUX |
| 15 | AUX | 16 | AUX |
| 17 | TRX+ | 18 | GND |
| 19 | TRX− | 20 | Vcc |

When compared with the comparative example in Table 1, pins No. 1 to No. 14 in Table 2 are the same as those in Table 1. However, the functions of pins No. 15 and larger in Table 2 are different from those of Table 1. That is, in the pin-out in Table 2, the following pins are arranged sequentially from the first end to the second end in the first arrangement surface 411, where the odd-numbered pins are arranged, of the connection port unit illustrated in FIG. 3: two pins for transmission of a differential signal (TX1+ and TX1−); one ground pin (GND); two pins for transmission of a differential signal (TX3+ and TX3−); one ground pin (GND); two pins each to be independently used (two AUX pins); and two pins for transmission and reception of a differential signal (TRX+ and TRX−). Alternatively, pins dedicated to reception of a differential signal (reception (RX)+ and RX−) may be provided instead of the TRX+ and TRX− pins.

In the second arrangement surface 412, where the even-numbered pins are arranged, the following pins are arranged sequentially from the first end to the second end: one ground pin (GND); two pins for transmission of a differential signal (TX2+ and TX2−); one ground pin (GND); two pins for transmission of a differential signals (TX4+ and TX4−); two pins each to be independently used (two AUX pins); one ground pin (GND); and one power source pin (Vcc).

The computer 10 illustrated in FIG. 1 includes the image transmission port unit, the pin-out of which is illustrated in FIG. 5 and listed in Table 2. The computer 10 corresponds to an example of an image transmission apparatus according to the present invention that transmits image data to the printer 20 through the image transmission port unit thereof.

Next, the pin-out as the comparative example illustrated in FIG. 4 and listed in Table 1 and the pin-out according to the present exemplary embodiment illustrated in FIG. 5 and listed in FIG. 2 are compared in terms of crosstalk noise.

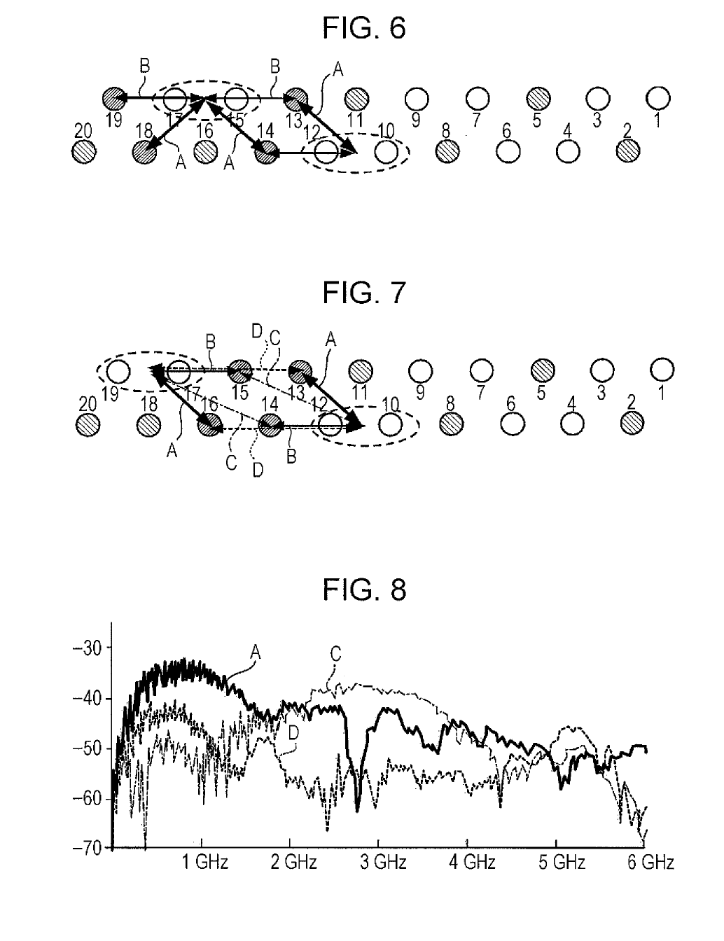

FIG. 6 illustrates the distances between the auxiliary pins and the pair of pins for transmission of a differential signal and between the auxiliary pins and the pair of pins for transmission and reception of a differential signal (such a pair of pins may also be referred to as an “aggressor pair” hereafter) in the comparative example in FIG. 4 and Table 1. As illustrated in FIG. 6, the distance between the pin No. 13 and the pair of pins No. 10 and No. 12 is defined as A, and the distance between the pin No. 14 and the pair of pins No. 10 and No. 12 is defined as B. At this time, the distances between the auxiliary pins No. 13, No. 14, No. 18, and No. 19 and the pair of pins No. 15 and No. 17 are B, A, A, and B, respectively. The total of these are expressed as “3A+3B” here.

FIG. 7 illustrates in a manner similar to FIG. 6 the distances between the pins according to the present exemplary embodiment illustrated in FIG. 5 and listed in Table 2.

The distances between the pairs of pins No. 10 and 12 and the auxiliary pins No. 13, No. 14, No. 15, and No. 16 are represented as A, B, C, and D, respectively. The distances between the pair of the pins No. 17 and No. 19 and the auxiliary pins No. 13, No. 14, No. 15, and No. 16 are represented as D, C, A, and B, respectively. The total of these distances are expressed as “2A+2B+2C+2D”.

When the pin-out in FIG. 6 (“3A+3B”) is compared with the pin-out in FIG. 7 (“2A+2B+2C+2D”), in the case where the sum of double the power of crosstalk noise introduced into a pin separated from the aggressor pair by the distance C and the double the power of crosstalk noise introduced into a pin separated from the aggressor pair by the distance D is weaker than the sum of the power of crosstalk noise introduced into a pin separated from the aggressor pair by the distance A and the power of crosstalk noise introduced into a pin separated from the aggressor pair by the distance B, crosstalk introduced into the auxiliary pins is reduced with the pin-out according to the present exemplary embodiment in FIG. 5 and Table 2 compared to the pin-out of the comparative example in FIG. 4 and Table 1. Thus, radiation noise from the auxiliary pins due to the crosstalk noise is reduced.

FIG. 8 illustrates measurement results of power of crosstalk noise at various frequencies (in GHz) of differential signals, the crosstalk noise being introduced into the auxiliary pins separated by the distances A, C, and D from the pairs of pins through which the differential signals are transmitted or received.

Because of a difficulty due to the pin-out, the power of the crosstalk noise introduced into the auxiliary pin separated from the aggressor pin by the distance B is not measured.

Despite this, according to FIG. 8, in a frequency band from 0.5 to 1.5 GHz, the power of crosstalk, which is introduced into one auxiliary pin separated from the aggressor pair by the distance A, is stronger than the sum of the power of crosstalk introduced into two auxiliary pins each separated from the aggressor pair by the distance C and two auxiliary pins each separated from the aggressor pair by the distance D. From this, it is understood that, even when no crosstalk is assumed to be introduced into the auxiliary pin separated from the aggressor pair by the distance B, in the 0.5 to 1.5 GHz frequency band, crosstalk noise is reduced more with the pin-out according to the present exemplary embodiment than with that of the comparative example, and accordingly, radiation noise from the auxiliary pins is reduced.

Here, although 2.125 GHz is assumed as the maximum frequency as described above, signals are rarely transmitted at the maximum frequency (2.125 GHz) and, in most cases, transmitted at a frequency band of 0.5 GHz to 1.5 GHz. When considering introduction of crosstalk noise in the auxiliary pins each separated from the aggressor pair by the distance B, crosstalk noise is reduced in a wider frequency band with the present exemplary embodiment.

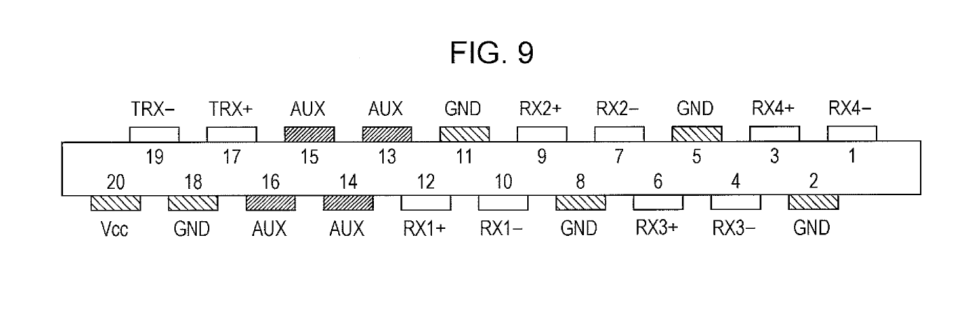

FIG. 9 is a pin-out of an image reception port unit equipped in the printer illustrated in FIG. 1.

Table 3 lists the pin-out of the image reception port unit illustrated in FIG. 9.

TABLE 3

| Pin No. | Function | Pin No. | Function |
|---|---|---|---|
| 1 | RX4− | 2 | GND |
| 3 | RX4+ | 4 | RX3− |
| 5 | GND | 6 | RX3+ |
| 7 | RX2− | 8 | GND |
| 9 | RX2+ | 10 | RX1− |
| 11 | GND | 12 | RX1+ |
| 13 | AUX | 14 | AUX |
| 15 | AUX | 16 | AUX |
| 17 | TRX+ | 18 | GND |
| 19 | TRX− | 20 | Vcc |

The pin-out in FIG. 9 and Table 3 corresponds to a pin-out in which “TXs” in the pin-out of the image transmission port unit in FIG. 5 and Table 2 are generally replaced with “RXs”.

That is, in this image reception port unit, the following ten pins are arranged sequentially from the first end to the second end in the first arrangement surface 411 (see FIG. 3), where the odd-numbered pins are arranged: two pins for reception of a differential signal (RX4− and RX4+); one ground pin (GND); two pins for reception of a differential signal (RX2− and RX2+); one ground pin (GND); two pins each to be independently used (two AUX pins); and two pins for transmission and reception of a differential signal (TRX+ and TRX−). Similarly to the case of the image transmission port unit, two pins for transmission of a differential signal (TX+ and TX−) may be provided instead of the two pins for transmission and reception of a differential signal (TRX+ and TRX−).

In the second arrangement surface 412 (see FIG. 3), where the even-numbered pins are arranged, the following ten pins are arranged sequentially from the first end to the second end: one ground pin (GND); two pins for reception of a differential signal (RX3− and RX3+); one ground pin (GND); two pins for reception of a differential signal (RX1− and RX1+); two pins to be independently used (two AUX pins); one ground pin (GND); and one power source pin (Vcc).

The same theory as that of the pin-out of the image transmission port unit described above is applicable to the pin-out of the image reception port unit. That is, crosstalk noise may be reduced more, and accordingly, radiation noise from the auxiliary pins may be reduced more with the pin-out according to the present exemplary embodiment than with the related-art pin-out of the connection port unit on the image reception side compliant with DisplayPort, which corresponds to the port unit on the image transmission side illustrated in FIG. 4 and listed in Table 1.

The image reception port unit having the pin-out illustrated in FIG. 9 and listed in Table 3 corresponds to an example of an image reception port unit according to the present invention, and the printer 20 (see FIG. 1) that includes this image reception port unit corresponds to an example of an image reception apparatus according to the present invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image transmission port unit having a first end and a second end, the unit comprising:
a first arrangement surface and a second arrangement surface, the second arrangement surface extending parallel to the first arrangement surface;
ten terminals that are arranged in a row in the first arrangement surface and spaced apart from one another by a predetermined pitch; and
ten terminals that are arranged in the second arrangement surface and spaced apart from one another by the same pitch as the pitch of the ten terminals in the first arrangement surface, a phase of the ten terminals in the second arrangement surface being shifted toward the second end by 180° relative to the ten terminals in the first arrangement surface,
wherein the ten terminals in the first arrangement surface include sequentially from the first end to the second end
two terminals for transmission of a differential signal,
one ground terminal,
two terminals for transmission of a differential signal,
one ground terminal,
two terminals each to be independently used, and
two terminals for reception or for transmission and reception of a differential signal, and
wherein the ten terminals in the second arrangement surface include sequentially from the first end to the second end
one ground terminal,
two terminals for transmission of a differential signal,
one ground terminal,
two terminals for transmission of a differential signal,
two terminals each to be independently used,
one ground terminal, and
one power source terminal.

2. An image transmission apparatus comprising:
the image transmission port unit according to claim 1, the image transmission apparatus transmitting image data through the image transmission port unit.

3. An image reception port unit having a first end and a second end, the unit comprising:
a first arrangement surface and a second arrangement surface, the second arrangement surface extending parallel to the first arrangement surface;
ten terminals that are arranged in a row in the first arrangement surface and spaced apart from one another by a predetermined pitch; and
ten terminals that are arranged in the second arrangement surface and spaced apart from one another by the same pitch as the pitch of the ten terminals in the first arrangement surface, a phase of the ten terminals in the second arrangement surface being shifted toward the second end by 180° relative to the ten terminals in the first arrangement surface,
wherein the ten terminals in the first arrangement surface include sequentially from the first end to the second end
two terminals for reception of a differential signal,
one ground terminal,
two terminals for reception of a differential signal,
one ground terminal,
two terminals each to be independently used, and
two terminals for transmission or for transmission and reception of a differential signal, and
wherein the ten terminals in the second arrangement surface include sequentially from the first end to the second end
one ground terminal,
two terminals for reception of a differential signal,
one ground terminal,
two terminals for reception of a differential signal,
two terminals each to be independently used,
one ground terminal, and
one power source terminal.

4. An image reception apparatus comprising:
the image reception port unit according to claim 3, the image reception apparatus receiving image data through the image reception port unit.

5. An image transmission and reception system comprising:
an image transmission apparatus comprising;
an image transmission port unit having a first end and a second end, the unit comprising:
a first arrangement surface and a second arrangement surface, the second arrangement surface extending parallel to the first arrangement surface;
ten terminals that are arranged in a row in the first arrangement surface and spaced apart from one another by a predetermined pitch; and
ten terminals that are arranged in the second arrangement surface and spaced apart from one another by the same pitch as the pitch of the ten terminals in the first arrangement surface, a phase of the ten terminals in the second arrangement surface being shifted toward the second end by 180° relative to the ten terminals in the first arrangement surface,
wherein the ten terminals in the first arrangement surface include sequentially from the first end to the second end
two terminals for transmission of a differential signal,
one ground terminal,
two terminals for transmission of a differential signal,
one ground terminal,
two terminals each to be independently used, and
two terminals for reception or for transmission and reception of a differential signal, and
wherein the ten terminals in the second arrangement surface include sequentially from the first end to the second end
one ground terminal,
two terminals for transmission of a differential signal,
one ground terminal,
two terminals for transmission of a differential signal,
two terminals each to be independently used,
one ground terminal, and
one power source terminal,
the image transmission apparatus transmitting image data through the image transmission port unit:
the image reception apparatus according to claim 4; and
a cable having one and another ends, the cable including,
a first connector at the one end of the cable, the first connector being connected to the image transmission port unit included in the image transmission apparatus, and
a second connector at the other end of the cable, the second connector being connected to the image reception port unit included in the image reception apparatus.
